(19) United States
(12) Patent Application Publication
(10) Pub. No.: US 2008/0019303 A1
(43) Pub. Date: Jan. 24, 2008

(54) Adaptive resource allocation for orthogonal frequency division multiple access

(75) Inventors: Andrew Baek, Irvine, CA (US); Thomas Cook, Tustin, CA (US)

Correspondence Address: STOEL RIVES LLP, 900 SW FIFTH AVENUE, SUITE 2600, PORTLAND, OR, 97204-1268, US

(73) Assignee: Troicom, Inc., Tustin, CA (US)

(21) Appl. No.: 11/491,505

(22) Filed: Jul. 21, 2006

(51) Int. Cl. H04Q 7/00

(52) U.S. Cl. 370/328

(57) ABSTRACT

Disclosed is an adaptive hardware resource allocation architecture that results in power consumption reduction. The architecture incorporates a novel concept in that the system resources can be optimally configured based on estimated processing requirements for the OFDMA mobile unit. The estimation is based on data burst attributes, data burst statistics, and message types.

### TECHNICAL FIELD

This invention relates in general to a communications system, method, and apparatus to adaptively allocate hardware resources to deal with changing data traffic loads in Orthogonal Frequency Division Multiple Access (OFDMA) systems. In particular, the method is intended for the power-constrained mobile unit in the system and is based on attributes of the data bursts and dynamic traffic patterns.

### BACKGROUND OF THE INVENTION

Modern wireless communications systems contain a baseband processing unit, which is typically comprised of the physical (PHY) and media access control (MAC) layers. Typically, the PHY layer is responsible for conditioning the sampled signal through filtering, channel estimation, modulation/demodulation, and channel coding. The MAC layer performs packetizing/depacketizing of the bits and processing the messages for applications and control.

In OFDMA, data is formatted into frames to be transmitted between the base station and the mobile unit. Since the base station maintains a number of communications links with multiple mobile units within the same cell, each frame contains many data bursts for the different users. Each data burst can be of a different size, depending on the application, and the burst size is negotiated between the base station and the mobile units through an allocation mechanism.

Typically communications systems are designed for the worst-case scenario of maximum load. Thus, system parameters, such as the processor clock speed and memory sizes, are chosen to accommodate the maximum processing requirement. This results in a rather inefficient usage of the hardware resource and high power consumption. Therefore, it is desirable to provide a dynamic resource allocation scheme that can optimally adapt to changing processing needs.

### SUMMARY

The scalable architecture described herein implements a dynamic resource management scheme for OFDMA systems, thereby minimizing the need to configure hardware resources in the system for the maximum load. Incoming data traffic is monitored and analyzed to determine an optimal allocation of the hardware resources.

In OFDMA, certain attributes of the data burst are specified in the beginning of the frame and need to be decoded prior to the bursts. Other information is received periodically in uplink and downlink channel descriptor messages. This information can be used to estimate the processing requirements. In addition, analysis can be performed to monitor dynamic characteristics of data traffic patterns to enhance the capability to monitor the data pattern and tune the system accordingly.

In one embodiment, the adaptive resource allocation system comprises a data pattern analyzer and a control signal generator. Preferably, the pattern analyzer uses the data burst attributes specified in the beginning of the frame and burst attributes specified in the channel descriptor messages to estimate processing requirements. The processing requirements are determined at the system level from the amount of data bursts and the different types of messages. After the processing requirements are estimated, the pattern analyzer may appropriately adjust values of the system control parameters. Preferably, the pattern analyzer provides the aggregate processing information to the control signal generator, which is responsible for configuring the functional blocks and memory blocks and for providing processing metrics to the processor. The processing metrics are used by scheduling algorithms in the processor, which optimally adjust processor clock speed to guarantee real-time operation for the software as a whole.

In one embodiment, the analyzer may have the capability to analyze dynamic data patterns and determine predictability of the overall resource requirement. The analyzer may also take into account how much the data pattern fluctuates over time. By monitoring the temporal pattern, the analyzer may determine how well it can dynamically track the resource requirements of the system.

In one embodiment, the analyzer may use processing feedback information from the processor. The processing feedback information may be provided by the processor's scheduling algorithms, in order to tune the processing metrics calculated by the analyzer. Because different service configurations will produce different loads on the processor, the processing feedback provides an adaptive mechanism that may further optimize the processor clock speed.

Additional aspects and advantages will be apparent from the following detailed description of preferred embodiments, which proceeds with reference to the accompanying drawings.

### BRIEF DESCRIPTION OF THE DRAWINGS

FIG. 1 shows a general block diagram of wireless communications systems.

FIG. 2 is a general frame structure of time domain division (TDD) OFDMA systems.

FIG. 3 is a canonical block diagram of the chipset with the hardware allocation manager.

FIG. 4 shows a functional block diagram of the HW allocation manager with input data and control signals.

FIG. 5 is a graph of power consumed during typical OFDMA usage, which shows processing gaps due to sparsely distributed data packets.

FIG. 6 is a graph of power consumed during maximum OFDMA data rates, which represents highly intensive computing during the downlink transmission and lower processing load during the uplink transmission.

### DETAILED DESCRIPTION Of PREFERRED EMBODIMENTS

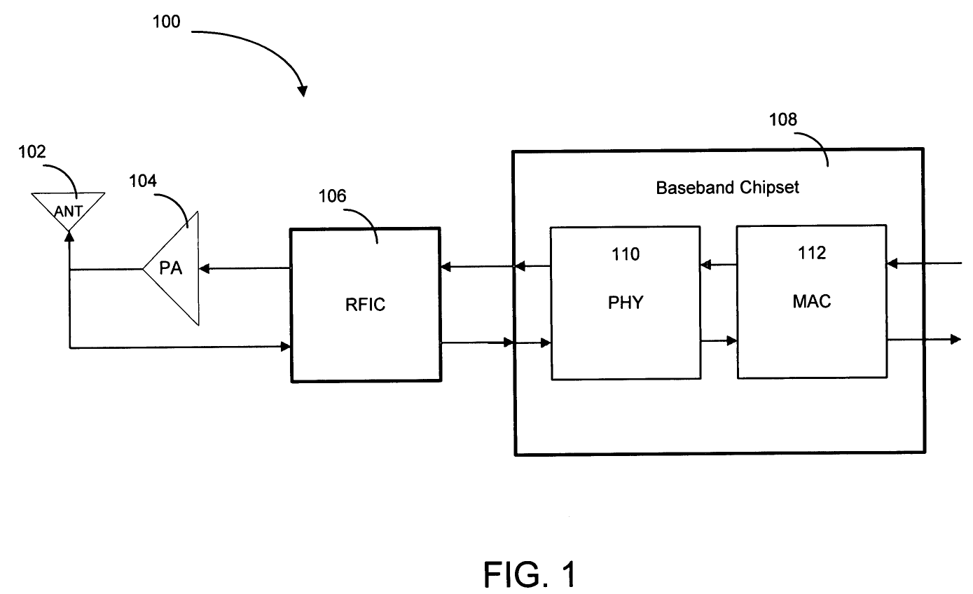

FIG. 1 shows a general block diagram of wireless communications systems 100. As demonstrated in FIG. 1, the wireless communications system comprises an antenna 102, a power amplifier (PA) 104, a radio frequency integrated circuits (RFIC) chip 106, and a baseband chip 108 comprised of the PHY 110 and MAC 112.

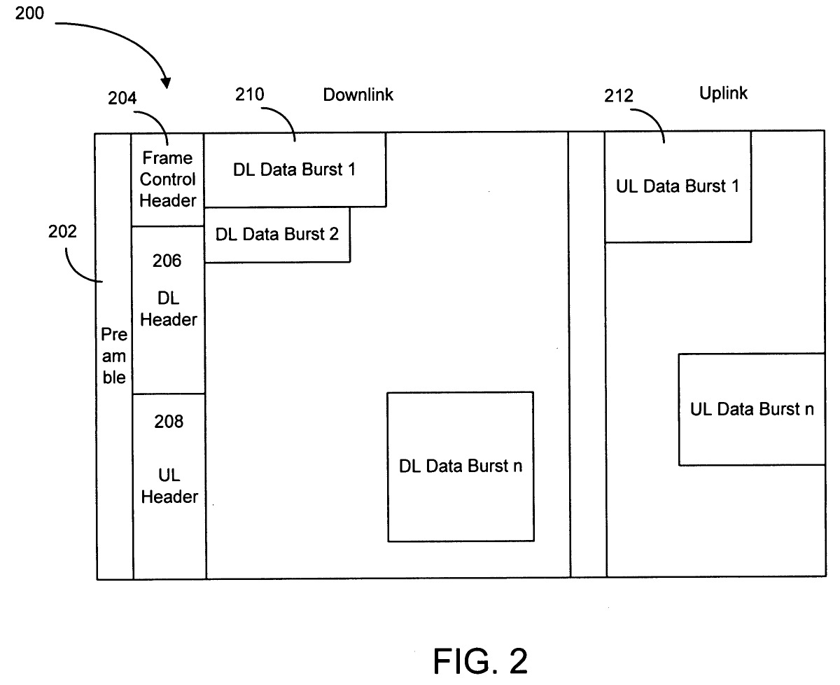

FIG. 2 represents a general structure of the OFDMA frame 200. The frame starts with a preamble 202 and three different headers 204, 206, and 208 for the frame, and downlink (DL) data bursts 210 and uplink (UL) data bursts 212. The preamble 202 is used for frame synchronization and contains the cell identification. The frame control header (FCH) 204 includes general information on the entire frame. The headers 204, 206, and 208 describe various properties of data bursts within the frame and provide information to extract the data bits. There is a separate DL header 206 and UL header 208. Both the DL header 206 and the UL header 208 describe all data bursts within the current frame or the following frame. FIG. 2 also depicts a few data bursts of different sizes dispersed within the frame.

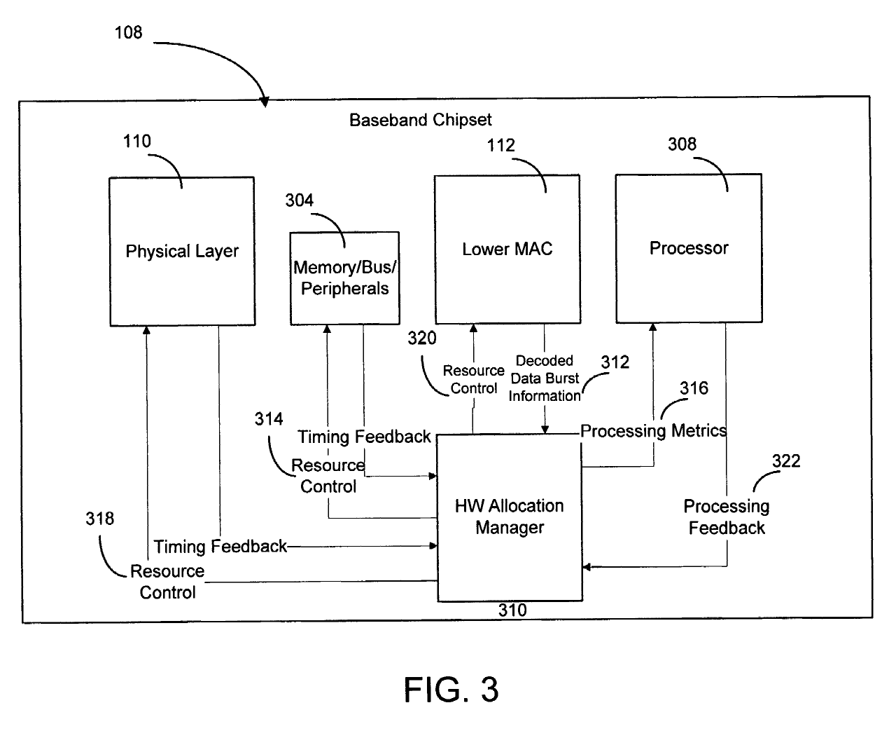

The block diagram of FIG. 3 shows an embodiment of the architecture of a baseband chipset 300. The baseband chipset 108 comprises a physical layer block 110, a memory/bus/peripherals block 304, a lower MAC 112, a processor 308, and a hardware (HW) allocation manager 310. The diagram shows decoded data burst information 312 flowing from the lower MAC 112 to the HW allocation manager 310. There are monitoring units in the physical layer block 110, the memory and peripherals 304, and the processor 308 to keep track of processing margin and the units send back the feedback information to the HW allocation manager 310. FIG. 3 also shows control signals 314 and 316 respectively flowing from the HW allocation manager 310 to the memory block 304 and the processor 308, and control signals 318 and 320 respectively flowing from the HW allocation manager 310 to the physical layer 110 and the lower MAC 112. The HW allocation manager 310 analyzes the information and determines optimal hardware resource configurations and generates control signals to configure the system resources.

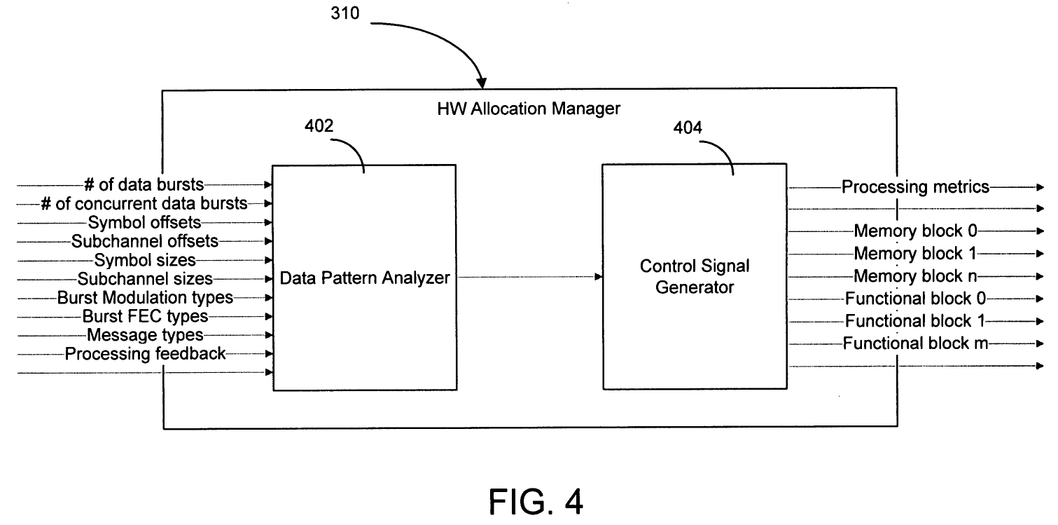

The HW allocation manager 310, shown in FIG. 4, comprises two functional blocks: the data pattern analyzer 402 and the control signal generator 404. The data pattern analyzer 402 uses properties of the frame and the dynamics of data bursts to determine the amount of data that needs to be processed by the processor 308 and the amount of memory and functional blocks that need to be allocated to process the data. The data pattern analyzer 402 uses from the FCH 204 a repetition coding number, the coding type, and the DL header size.

The data pattern analyzer 402 receives the following information from a DL header decoder for each of the DL data bursts 210 that the mobile needs to process: the symbol offset, the subchannel offset, the number of symbols, the number of subchannels, and the repetition coding number. The data pattern analyzer 402 also receives the following parameters from the UL header decoder for each of the UL data bursts 212 that the mobile needs to transmit: the symbol offset, the subchannel offset, the number of symbols, the number of subchannels, and the repetition coding indication.

The data pattern analyzer 402 also assesses channel descriptor messages. In a downlink channel descriptor message, the data pattern analyzer 402 receives the following information from the MAC layer 112 for the downlink bursts: burst modulation and forward error correction (FEC) type. The data pattern analyzer 402 receives the following information from the MAC layer 112 for the uplink bursts, which is received in an uplink channel descriptor message: burst modulation and FEC type.

The data pattern analyzer 402 then determines the amount of data that needs to be processed by the processor 308 according to the following equation:

$$K = {\sum }_{i = 1}^{I} {p}_{i} + {\sum }_{j = 1}^{m} {q}_{j} \\ Total size of DL \text{/} UL data bursts that need to be processed . \qquad Equation 1$$

### In equation 1, pᵢ is the i^{th} DL data burst size and qⱼ is the j^{th} UL data burst size.

The data pattern analyzer 402 also takes into consideration the following burst-related information:
The total number of data bursts to process.
The number of concurrent data bursts to process.

The data pattern analyzer 402 may also take into consideration the types of control messages and their associated processing requirements. The following may be a typical set of messages:
Messages to describe the uplink and downlink channels.
Messages related to ranging process.
Messages to manage and negotiate security associations and parameters.
Messages to request service flow additions/deletions/changes.
Messages to control handoff operations.
Messages to control sleep mode operations.
Messages to control diversity operations.
Messages to measure channel conditions.

The data pattern analyzer 402 also receives feedback 322 from the processor 308. The processing feedback 322 is used by the data pattern analyzer 402 to tune its processing metrics calculations. Once the FCH information is processed and decoded, the data pattern analyzer 402 computes the associated processing metrics 316. The processing metrics 316 for the system will vary depending on the number, sizes, and types of data bursts; and the number, sizes, and types of messages. So, in order to estimate the overall processing requirements, a cost matrix computation is defined:

$$B = WA \\ [ \begin{matrix}{b}_{1} \\ {b}_{2} \\ ⋮ \\ {b}_{m}\end{matrix} ] = [ \begin{matrix}{w}_{11} & {w}_{12} & ⋯ & {w}_{1 n} \\ {w}_{21} & {w}_{22} & ⋯ & {w}_{2 n} \\ ⋮ & ⋮ & ⋮ & ⋮ \\ {w}_{m 1} & {w}_{m 2} & ⋯ & {w}_{mn}\end{matrix} ] [ \begin{matrix}{a}_{1} \\ {a}_{2} \\ ⋮ \\ {a}_{n}\end{matrix} ] \\ Cost metrics computation . \qquad Equation 2$$

In equation 2, the array A represents the number of bursts and messages of different types/sizes, n types in total. The elements in weight matrix W represent how much impact each input, aᵢ, has on the system parameters, bᵢ's. Weight matrix W can be pre-computed and adjusted by the processing feedback 322 from the processor 308, to tune the computation. The elements in array B are related to the system parameters.

The data pattern analyzer 402 will also monitor the data traffic's dynamic pattern. If the pattern is consistent and predictable, the HW allocation manager 310 can be more aggressive in terms of setting up the system parameters in equation 2. Predictability and consistency of a data pattern may be determined by the following equation:

PL=(1+c×δ(var(PLₘᵢₙ)))×PLₘᵢₙ Equation 3 Processing Load.

where PL is the final processing load, PLₘᵢₙ is the minimum processing load computed from the total data burst size K and processing metrics cost matrix computation W. δ(var(PLₘᵢₙ)) measures the variance of PLₘᵢₙ over time. Large fluctuation will increase δ to ensure sufficient processing margin of the system. c is a proportionality constant.

If the data stream is constant over time, δ will become small. For instance, constant low data rate traffic such as voice-over-IP (VOIP) can be rather predictable, thus a smaller δ.

The control signal generator 404 provides information to adjust the following system parameters:
Processing metrics.
Power-manage memory blocks.
Power-manage functional blocks.

The data pattern analyzer 402 uses feedback information 322 from the processor 308 to tune the processing metrics calculation. The processing feedback information 322 is derived from measuring the time the processor 308 takes to process data bursts and messages of varying types and sizes.

The processor 308 provides processing feedback 322 to the data pattern analyzer 402 based on its own analysis of the processing requirements of data bursts and messages of varying types and sizes. Because the processing time may vary with changes in the service configuration, the processor 308 tracks real-time processing requirements of various operations. Processing feedback 322 is then provided to the data pattern analyzer 402, adaptively optimizing the calculated processing metrics 316.

Upon reset to its initial state, the processor 308 uses its processing feedback mechanism to tune the data pattern analyzer 402 to provide conservative processing metrics 316 to the processor 308. This protects against processing time starvation in the processor 308.

As processor tasks are performed, the processor 308 times the execution time to complete the task, t. A processor task is defined to be the complete processing of a single data burst or message of a specific type and size and t is defined as the time to complete a processor task. The processor 308 then normalizes t to account for the processor clock speed during the execution context. The normalized time the processor 308 takes to perform a processor task is represented by the symbol τ. The normalized timing value, τ, is used by the processor 308 to estimate future requests for the same processing task and to improve the data pattern analyzer's processing metrics calculation, by use of the processing feedback mechanism.

The normalization of the processor task execution time is shown in Equation 4, where C_{N} is the processor clock speed normalization constant, F_{current} is the current processor clock speed, and Fₘₐₓ is the maximum configurable processor clock speed.

$$τ = t * {C}_{N} \\ where \\ {C}_{N} = \frac{{F}_{current}}{{F}_{max}} \\ Normalization of Processor Task Execution Time . \qquad Equation 4$$

Because τ is tracked independent of the operating processor clock speed, it is filtered to provide an adaptive means of optimizing processor clock speed estimation for the corresponding processor task. The following equation represents the filtered normalized timing value:

τₙ=f(τₙ₋₁) Equation 5 Filtered normalizing timing value.

where n is the current processor task execution measurement index, and f() is the adaptive filtering algorithm. The processing feedback 322 for each processor task is proportional to the value τ for the processor task. The set of processing feedback is derived from the τ value for each processor task.

The processing feedback derivation is shown in Equation 6, where the array FB represents a set of the feedback values for the processor tasks, S represents the proportional scale value, the array T represents the array of normalized processor task execution times, τ, and n represents the total number of processor tasks.

$$FB = S * T \\ [ \begin{matrix}{FB}_{1} \\ {FB}_{2} \\ ⋮ \\ {FB}_{n}\end{matrix} ] = S [ \begin{matrix}{τ}_{1} \\ {τ}_{2} \\ ⋮ \\ {τ}_{n}\end{matrix} ] \\ Calculation of Processing Feedback . \qquad Equation 6$$

This adaptive approach may substantially reduce power consumption, compared to traditional architectures, due primarily to a reduction in the processor clock speed and active periods of the memory and functional blocks.

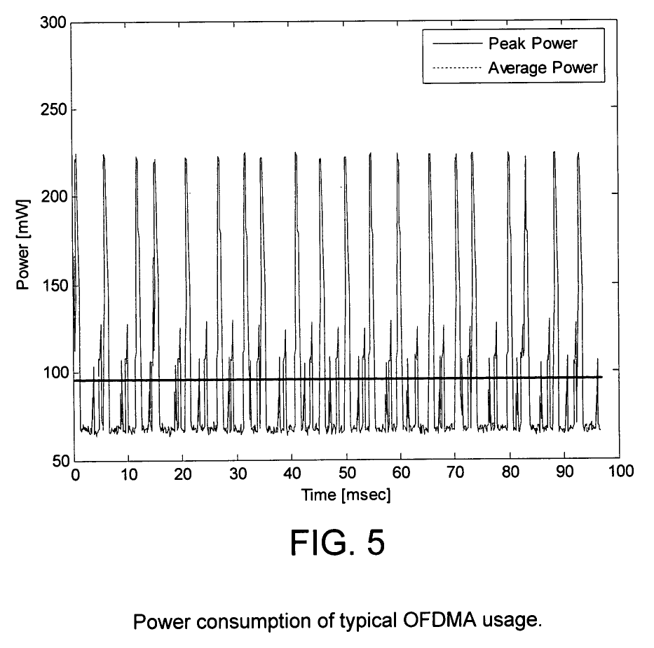

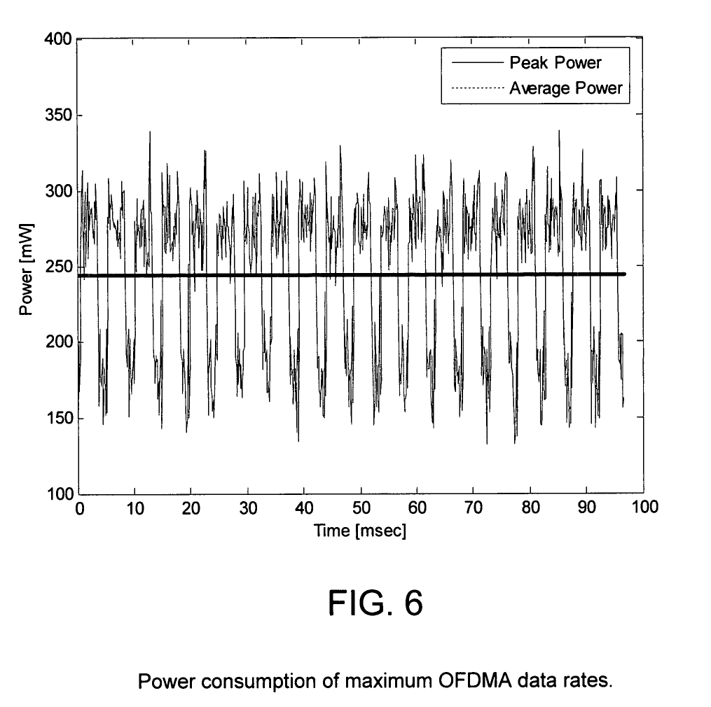

Two cases were simulated to describe the power saving benefit of the adaptive resource allocation technique: typical and high data rate usages. Without the adaptive allocation, the baseband SOC for the current OFDMA standard is estimated to consume ˜530 mW as shown in Table 1. The allocation scheme can reduce the power consumption by more than five times for the typical usage. The reduction comes from the optimized processor and memory configuration as well as powering certain functional blocks in the physical layer only for a fraction of the frame period. The simulation results for typical and maximum usages are shown in FIG. 5 and FIG. 6, respectively.

TABLE 1
Power saving advantage of ARM technology. The technology reduces
power consumption by more than 5 times for typical usage and more than
twice even for the maximum rate.

| | Without ARM | Typical with | Max Rate Usage |
|---|---|---|---|
| | (mW) | ARM (mW) | with ARM (mW) |
| PHY | 302 | 54.5 | 149 |
| Low MAC | 20 | 1 | 1 |
| Memory/ | 131 | 37.9 | 82.9 |
| Bus/ | | | |
| Peripherals | | | |
| Processor | 80 | 2 | 10.9 |
| Total | 533 | 95.4 | 243.8 |

Simulation parameters that were used for FIG. 5 are shown below.
Downlink rate: 345 kbps
Uplink rate: 86 kbps
Ptotal=Pstatic+Pdynamic
Average Ptotal: 96 mW
The plot shows statistically distributed data bursts.

Simulation parameters that were used for FIG. 6 are shown below.
Downlink rate: 18 Mbps
Uplink rate: 7.8 Mbps
Clockless blocks:
   Processor: ARM 996HS
   Synchronization: Rx filters, NCO, timing/frequency recovery
Average Ptotal: 243 mW
The plot shows high power consumption during the computationally intensive receive processing and the power requirement relaxes for the transmit.

It will be obvious to those having skill in the art that many changes may be made to the details of the above-described embodiments without departing from the underlying principles of the invention. The scope of the present invention should, therefore, be determined only by the following claims.

1. A hardware resource allocation manager for implementing dynamic resource allocation for an orthogonal frequency division multiple access transceiver, wherein the transceiver processes a frame, the frame comprising header information and data, the hardware allocation manager comprising:
means for analyzing the header information to estimate at least one of memory allocation requirements, functional block configuration requirements, and processing requirements for processing the data; and
means for adaptively allocating at least one of processing resources of a processor responsive to the processing requirements, a quantity of memory blocks available to the processor responsive to the memory allocation requirements, and configuration of functional blocks available to the processor responsive to the functional block configuration requirements.

2. A hardware allocation manager according to claim 1, further comprising:
means for observing variations in the header information over a plurality of frames; and
means for including the observed variations in estimating at least one of the memory allocation requirements, the functional block configuration requirements, and the processing requirements.

3. A hardware allocation manager according to claim 1, wherein a processor is coupled to the hardware allocation manager to provide processor feedback information, and the hardware allocation manager comprises means for including the processing feedback information in estimating at least one of the memory allocation requirements, the functional block configuration requirements, and the processing requirements.

4. A hardware allocation manager according to claim 3, wherein the processor measures an amount of time the processor takes to process the data; and
the processor communicates the amount of time to the hardware allocation manager as the processing feedback information.

5. A hardware allocation manager according to claim 1, wherein the hardware allocation manager determines at least one of the processing resources, the quantity of memory blocks available to the processor, and the configuration of functional blocks available to the processor from:
a number of data bursts and a number of messages;
sizes of data bursts and sizes of messages; and
types of data bursts and types of messages.

6. A hardware allocation manager according to claim 1, wherein the hardware allocation manager receives a repetition coding number, a coding type, and a downlink header size from the header information to estimate at least one of the memory allocation requirements, the functional block configuration requirements, and the processing requirements.

7. A hardware allocation manager according to claim 1, wherein the header information is located in a downlink header and an uplink header.

8. A hardware allocation manager according to claim 7, wherein the hardware allocation manager receives symbol offset information, subchannel offset information, a number of symbols, a number of subchannels, and a repetition coding number from the downlink header to estimate at least one of the memory allocation requirements, the functional block configuration requirements, and the processing requirements.

9. A hardware allocation manager according to claim 7, wherein the hardware allocation manager receives symbol offset information, subchannel offset information, a number of symbols, a number of subchannels, and a repetition coding indication from the uplink header to estimate at least one of the memory allocation requirements, the functional block configuration requirements, and the processing requirements.

10. A hardware allocation manager according to claim 1, wherein the hardware allocation manager receives information located in at least one of uplink channel descriptor messages and downlink channel descriptor messages to estimate at least one of the memory allocation requirements, the functional block configuration requirements, and the processing requirements.

11. A hardware allocation manager according to claim 10, wherein the information located in at least one of the uplink channel descriptor messages and the downlink channel descriptor messages comprises:
burst modulation type; and
forward error correction type.

12. A hardware allocation manager according to claim 1, wherein said hardware allocation manager comprises:
a data pattern analyzer; and
a control signal generator.

13. A method for dynamically allocating at least one of processor resources, memory resources, and functional block resources in an orthogonal frequency division multiple access transceiver to improve power consumption, comprising:
receiving a current frame, the current frame comprising header information and data;
determining from the header information, at least one of processing requirements, memory allocation requirements, and functional block configuration requirements for processing the data of the current frame;
adjusting at least one of a processor clock speed of the transceiver responsive to the processing requirements, a quantity of memory blocks available to a processor of the transceiver responsive to the memory allocation requirements, and a configuration of functional blocks available to the processor of the transceiver responsive to the functional block configuration requirements.

14. A baseband chip for an orthogonal frequency division multiple access transceiver, comprising:
a physical layer;
a memory;
a lower MAC;
a processor; and
a hardware allocation manager, wherein
the lower MAC provides decoding of packet header information;
the hardware allocation manager is coupled to receive the decoded packet header information; and
the hardware allocation manager communicates with at least one of the memory to adaptively adjust a quantity of memory blocks available to the processor, the physical layer and the lower MAC to adaptively adjust a configuration of functional blocks available to the processor, and the processor to adaptively adjust a processor clock speed responsive to changes in data traffic loads reflected in the decoded packet header information.

15. A method for dynamically allocating at least one of processor resources, memory resources, and functional block resources in an orthogonal frequency division multiple access transceiver to improve power consumption, comprising:
receiving a series of frames, each frame comprising corresponding header information;
determining at least one of processing requirements, memory allocation requirements, and functional block configuration requirements from the corresponding header information;
monitoring how much at least one of the processing requirements, the memory allocation requirements, and the functional block configuration requirements vary over time;
adjusting at least one of a processor clock speed of the transceiver responsive to a variance of the processing requirements over time, a quantity of memory blocks available to a processor of the transceiver responsive to a variance of the memory allocation requirements over time, and a configuration of functional blocks available to the processor of the transceiver responsive a variance of the functional block configuration requirements over time.
